(19) United States
(12) Patent Application Publication
(10) Pub. No.: US 2010/0206238 A1
(43) Pub. Date: Aug. 19, 2010

(54) Cat Litter Box Cabinet System

(76) Inventor: Paul Pettys, Rock Hill, SC (US)

Correspondence Address: CLIFFORD H. KRAFT, 320 ROBIN HILL DR., NAPERVILLE, IL, 60540, US

(21) Appl. No.: 12/766,865

(22) Filed: Apr. 24, 2010

Related U.S. Application Data
(63) Continuation-in-part of application No. 11/710,850, filed on Feb. 26, 2007, now abandoned.
Application No. 11/710,850 is a continuation-in-part of application No. 11/144,562, filed on Jun. 3, 2005, now abandoned.

(51) Int. Cl. A01K 29/00

(52) U.S. Cl. 119/169

(57) ABSTRACT

A cat litter containment enclosure system with four walls that locates a litter container at an elevated level preferably on a shelf where a cat enters the enclosure from a port in a front panel and hops or jumps to a second level for access to a litter container. The enclosure can contain a second pad located on the second level near the litter container so that the cat's paws are cleaned as the cat exits the enclosure. The top and front panel of the enclosure can be hinged for easy access for cleaning and/or inspection. Translucent vent holes can also be supplied on the enclosure for air and light. The pet can enter either from the front, or in other embodiments from the side of the enclosure.

This is a continuation-in-part of co-pending application Ser. No. 11/710,850 filed Feb. 26, 2007 which was a continuation-in-part of application Ser. No. 11/144,562 filed Jun. 3, 2005, now abandoned. Application Ser. Nos. 11/710,850 and 11/144,562 are hereby incorporated by reference.

### BACKGROUND

1. Field of the Invention

The present invention relates to the general field of pet waste disposal and more particularly to a self-contained litter box cabinet system.

2. Description of the Prior Art

Litter boxes are well-know methods of handling the problem of indoor cat waste. The classical problem with a litter box is that it is usually in the open and is therefore accessible to children and other household pets. In addition, there may be unpleasant odors associated with an open litter box.

Another problem with an open litter box is that cats normally track particles out of the litter box when they leave or thrash and throw out particles. These particles can be particularly damaging to floors and the like as well as creating the possibility of spreading unwanted cat-waste into the house.

Cat owners who also own dogs are aware that dogs tend to eat cat waste from an open litter box. This can cause the dog to become sick.

Baille et al. in U.S. Pat. No. 5,092,277 teach a cat litter containment system which includes a closed housing. Ballie's system uses a screen that the cat must walk down to clean the cat's paws.

Baille et al. in U.S. Pat. No. 5,361,725 teach a carryable enclosure where a cat walks across a screen before reaching a litter box.

The applicant, in a prior system, taught a closed box with two doors that had a litter box on a second shelf recessed into the shelf. A small opening appeared in one of the doors. The entire assembly was raised with a “kick” along the front bottom. The door did not come down all the way to the floor.

Nowhere in the prior art is the problem of an out of sight litter box solved where the litter box material cannot be thrown out of the enclosure and cat can walk on a solid flat surface on its way to and from the litter box, and where a larger and older cats can be accommodated.

### SUMMARY OF THE INVENTION

The present invention relates to a cat litter containment enclosure system with four walls that locates a litter container at an elevated level preferably on a shelf where a cat can enter the enclosure from a port on the ground level in a front panel, walk on a pad, preferably of ASTROTURF (ASTROTURF is a registered trademark of Astroturf Industries, Inc.) or similar material, then hop or jump up to the a second level to reach a litter container. The enclosure can contain an optional second pad located on the second level where the litter container is located so that the cat's paws are cleaned as the cat exits the enclosure. The top and front panel of the enclosure can be hinged for easy access for cleaning and/or inspection. The present invention allows the litter container to be out of sight to prevent scattering of litter material onto floors, eating of cat-waste by dogs and propagation of undesired odors. The size of the opening helps keep dogs and children out of the unit. The door of the present invention is at floor level and large enough to accommodate larger cats. The litter container is on a shelf low enough that older cats can make the jump.

### DESCRIPTION OF THE FIGURES

Attention is now directed to several figures:

FIG. 1 shows a front perspective view of an embodiment of the present invention.

FIG. 2 shows the embodiment of FIG. 1 with the top open.

FIG. 3 shows the embodiment of FIGS. 1-2 with the front door open.

FIG. 4 is a top down view.

FIG. 5 is a sectional side view.

FIG. 6 is a perspective view of an improved embodiment of the present invention where the door comes down floor level.

FIG. 7 is a back view of the embodiment of FIGS. 6-7.

Several illustrations and drawings have been presented to aid in the understanding of the present invention. The scope of the present invention is not limited to the figures.

### DESCRIPTION OF THE INVENTION

The present invention relates to an “out of sight” cat litter box that solves the problems of litter being spread on floors, dogs eating cat wastes, odors and the like.

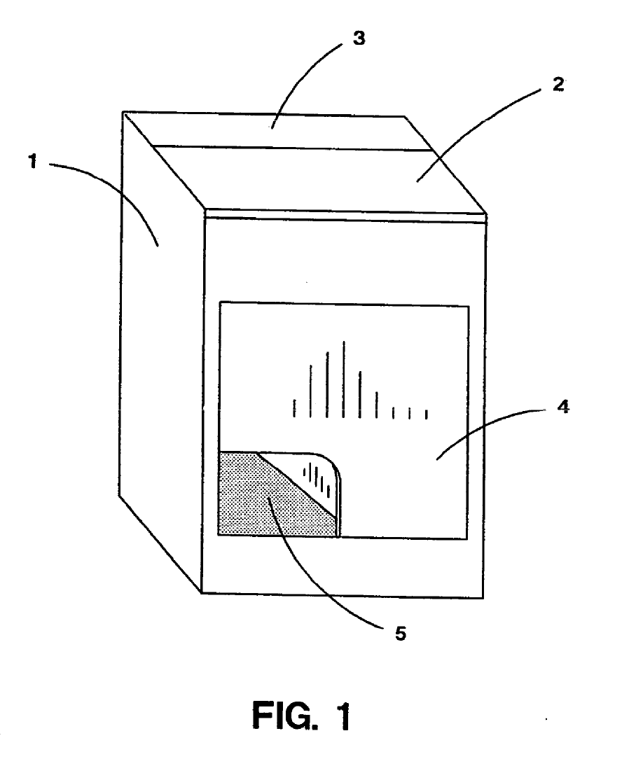

FIG. 1 shows a perspective view of an embodiment of the present invention. An enclosure 1 contains a 2-part top with a fixed part 3 and a part that can be opened 2. The front of the enclosure 1 has a door 4 with an opening that a cat can enter. A cat learns that to use the litter system, it must enter through the opening into the enclosure, and then hop or jump up to a second level. It should be understood that the door 4 through which the pet enters can be on either side toward the front as well as in the front. For example, the pet might enter the left side of the enclosure 1 to encounter a pad just as in a front door system.

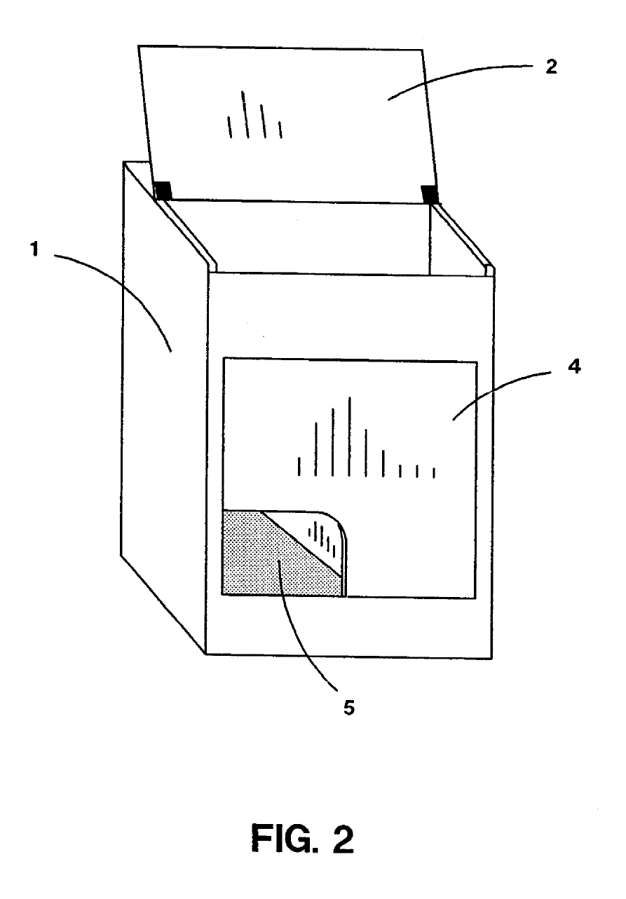

FIG. 2 shows the embodiment of FIG. 1 with the lid 2 open. Opening this lid 2 allows the cat owner to access the litter container that is located in the upper part of the device. The access lid 2 can be attached to the fixed part 3 by a pair of hinges or by any other attachment device or method.

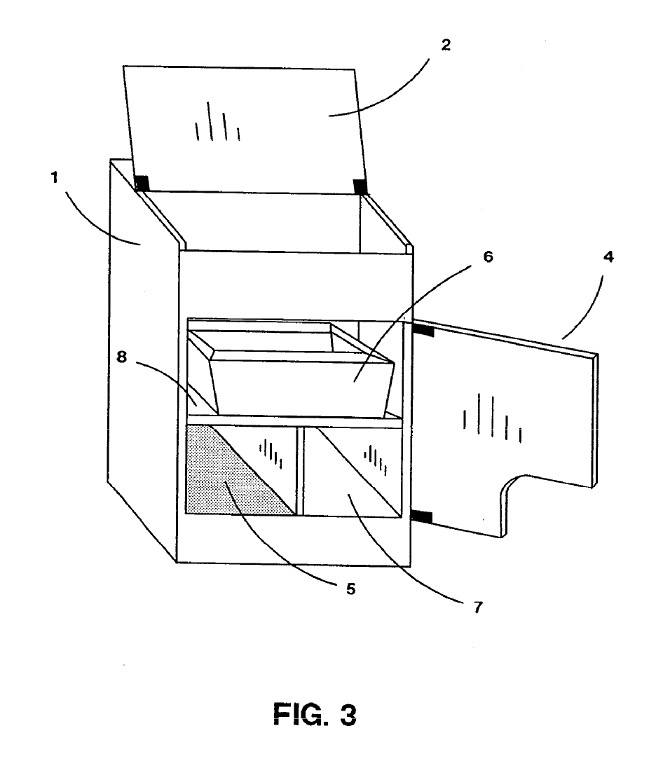

Turning to FIG. 3, the embodiment of the present invention is seen with both the lid 2 and the front door 4 open. The entrance with a pad 5 can be clearly seen. The cat must walk through the padded entrance to reach the litter container 6 that is located on the upper level. The preferred size litter container is around 15×19 inches; however, any size container is within the scope of the present invention. The act of walking on the pad 5 cleans the paws of the cat. An extra compartment 7 can be seen in FIG. 3 which can be used to store accessories or anything else. The litter container 6 can rest on a shelf 8.

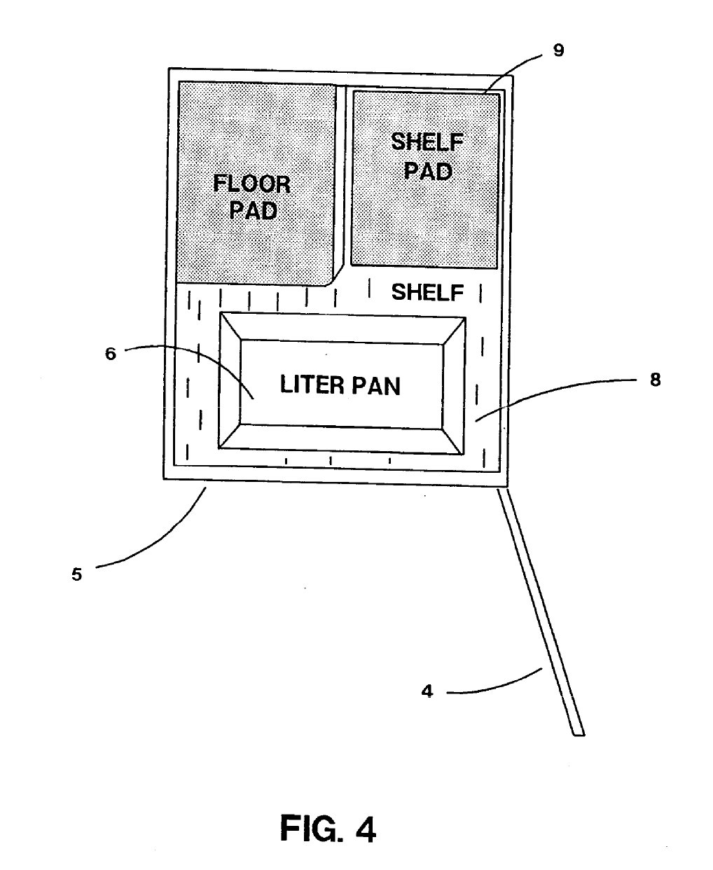

FIG. 4 shows a top-down view of the embodiment of FIG. 1 with the lid not shown. The shelf 8 can hold a litter container 6 (shown in FIG. 3). The padded entrance 5 where the cat hops or jumps to a second level shelf 8. The cat merely jumps from the second level pad 9 into the litter box 6. When the cat is finished, it jumps back onto the second level pad 9 and then jumps to the first level pad 5 to exit the enclosure 1. By walking across the pads 9, 5, the cat's paws are cleaned so that litter is not tracked out of the enclosure into the house.

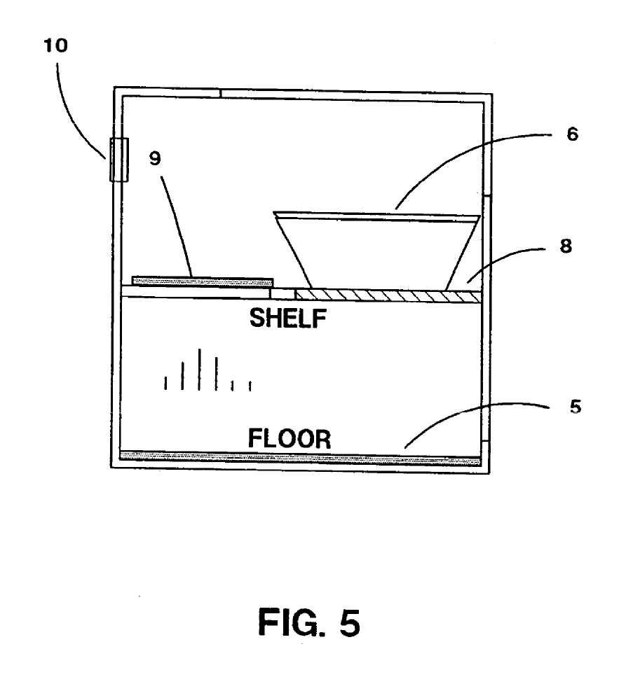

FIG. 5 shows a sectioned side view of the embodiment of FIG. 4. The entrance pad 5 can be clearly seen leading into the cabinet from where the cat hops or jumps to the second level pad 9 which is located on the shelf 8. The litter box 6 also rests on the shelf 8. The cat walks into the entrance, jumps to the second level shelf and into the litter box. The back panel of the enclosure 1 can have optional ventilation holes 10.

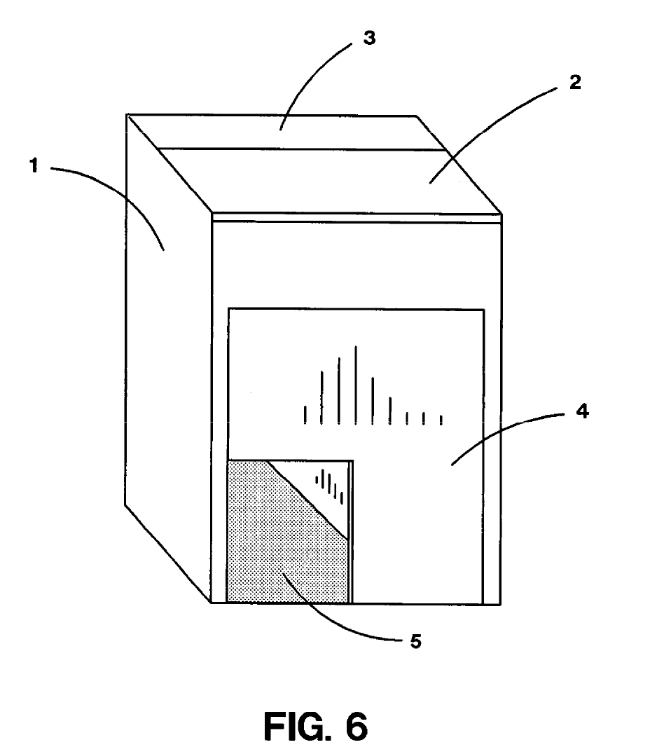

FIG. 6 shows an improved embodiment of the present invention. One of the problems with the prior art and the previous embodiments herein described is that larger cats may not be able to get into a small doorway. Also, the other embodiments had the bottom of the door around 6 inches above the floor requiring the cat to hop in. The embodiment of FIG. 6 has a door that is flush with the floor allowing the cat to simply walk in. The door size has been increased from around 6×8 inches to around 10×10 inches to accommodate larger cats. While this is the preferred door size, any door size with within the scope of the present invention. In this embodiment, the shelf has been lowered from around 17 inches to around 10 inches. This allows older cats to make the jump as well as younger cats. While this is a preferred height for the shelf, any height is within the scope of the present invention. It can be seen that in this embodiment, the litter pan has been made smaller, and in both embodiments, that it sits on the shelf rather than being recessed into the shelf. This structure gives the shelf more strength. Optionally, the front edge of the structure can contain a dip that prevents the lid from smashing fingers if it falls.

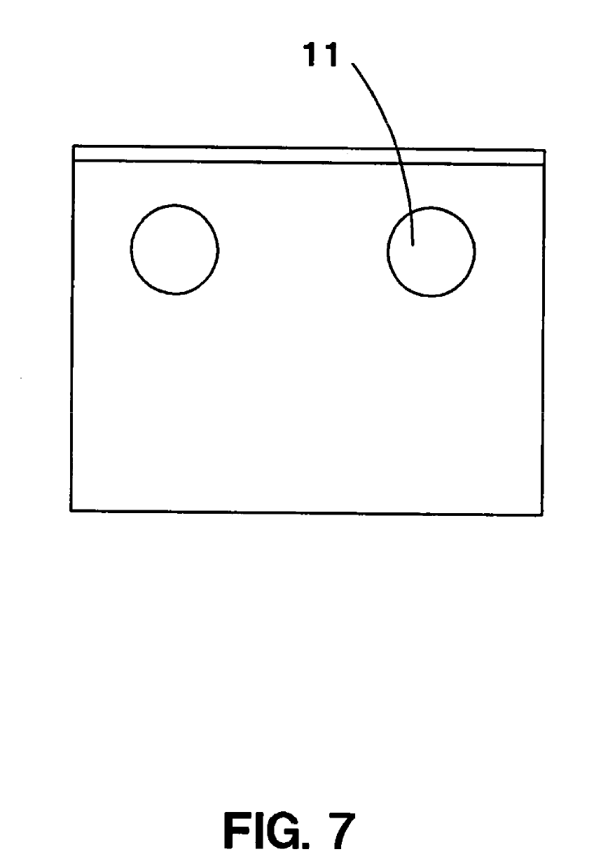

FIG. 7 shows a rear view of the embodiments of FIG. 6. One or more translucent vents 10 can be seen. These optional vents allow air to circulate into the enclosure and allow light to enter so that it is not dark inside.

The cat litter cabinet system of the present invention can be made from any convenient material. The preferred material is any form of wood or plastic. Hinges, or any other fasteners, can be used to allow the lid and door to open. The padding on the first and second level can be ASTROTURF, or any other convenient padding material. The entrance hole can be made large enough to accommodate a large cat. Dogs will normally not try to enter into the small enclosure. The litter box is easily cleaned and filled from the top, and the entire unit is accessible for cleaning and inspection from the front.

Several descriptions and illustrations have been presented to better aid in understanding the present invention. A person of skill in the art will recognize that many changes and variations are possible. All such changes and variations are within the scope of the present invention.

I claim:

1. A cat litter box enclosure comprising:
a generally rectangular 3-dimensional box having a front, side walls, a rear wall, a floor and a hinged lid, said box being vertically divided into an upper level and a lower level by a horizontal shelf, said horizontal shelf having a hole or missing area in a right rear portion;
said lower level of said box also being horizontally divided into a right part and a left part by a vertical partition running fore and aft between said rear wall and said front, said vertical partition extending from said floor to said shelf;
a single hinged door closing the box front, said door having a ground-level entrance port for entry into the right lower front part, said door, entrance port and vertical partition forming a tunnel from front to back in the lower right level of said box;
the floor in said tunnel being padded fore and aft with a floor pad;
the shelf also being padded on an upper surface in a left rear portion by a shelf pad;
said entrance port, tunnel and shelf being disposed so that a cat can enter the entrance port stepping only on said floor pad, and hop or jump upward through said hole from the lower level to the upper level to the shelf stepping on said shelf pad to access a litter container disposed on a front portion of said shelf;
at least one translucent vent in the rear wall, said vent passing both air and light into the enclosure.

2. The cat litter box enclosure of claim 1 wherein said entrance port is around 10×10 inches.

3. The cat litter box enclosure of claim 1 wherein said shelf is around 10 inches above the floor.

4. The cat litter box enclosure of claim 1 wherein said hinged lid includes hinges located near the rear wall of the box.

5. The cat litter box enclosure of claim 1 wherein said single front door is hinged to said box on a left side.

6. The cat litter box enclosure of claim 1 wherein said hinged lid includes a fixed part rear and a movable front part, said movable front part hinged to said fixed rear part.

7. The cat litter box enclosure of claim 1 wherein the left part of said lower level itself forms a closed box usable as a storage area.

8. A cat litter box enclosure comprising:
a generally rectangular 3-dimensional box having a front, side walls, a rear wall, a floor and a hinged lid, said box being vertically divided into an upper level and a lower level by a horizontal shelf, said horizontal shelf having a hole or missing area in a right rear portion;
said lower level of said box also being horizontally divided into a right part and a left part by a vertical partition running fore and aft between said rear wall and said front, said vertical partition extending from said floor to said shelf;
a front panel totally closing the box front;
a vertical partition forming a tunnel from front to back in the lower right level of said box;
an entrance port into said tunnel from a left side of said box; the floor in said tunnel being padded fore and aft with a floor pad;
the shelf also being padded on an upper surface in a left rear portion by a shelf pad;
said entrance port, tunnel and shelf being disposed so that a cat can enter the entrance port stepping only on said floor pad, and hop or jump upward through said hole from the lower level to the upper level to the shelf stepping on said shelf pad to access a litter container disposed on a front portion of said shelf.
